(19) United States
(12) Patent Application Publication
(10) Pub. No.: US 2004/0002914 A1
(43) Pub. Date: Jan. 1, 2004

(54) Method for extended term financing using time drafts

(76) Inventor: Jacques Munro, Kew Gardens, NY (US)

Correspondence Address: Bierman, Muserlian and Lucas, 600 Third Avenue, New York, NY, 10016, US

(21) Appl. No.: 10/180,252

(22) Filed: Jun. 26, 2002

(51) Int. Cl. G06F 17/60

(52) U.S. Cl. 705/38

(57) ABSTRACT

This invention relates to a method of extended term financing using financial instruments known as time drafts. A seller sells goods and services to a buyer pursuant to a purchase agreement that includes extended term financing of the purchase price. The seller also prepares and sends to buyer a time draft specifying a specific payment amount at a specific future due date. The seller encodes buyer's bank account information on the time draft. The buyer signs the time draft and returns it to seller. A finance company buys the time draft from seller and pays the seller a single payment equal to the full purchase price minus a service fee. On the due date, the time draft becomes the equivalent of a regular check, and the buyer pays the time draft through normal banking channels.

### BACKGROUND OF THE INVENTION

This invention relates to a method of extended term financing using financial instruments known as time drafts.

In the banking and financing industries, the term “draft” is normally defined as “an order for the payment of money drawn by one person or bank on another.” The term “time draft” is normally defined as “a draft payable a specified number of days after date of the draft or presentation to the drawee.” These and other related terms are further defined in Barron's Dictionary of Banking Terms, 3^{rd} Ed., 1997, and in Article 3 of the Uniform Commercial Code (UCC), for example UCC Sections 3-102 and 3-104.

A time draft may be “accepted” by the drawee. Once accepted, the draft is the equivalent of a promissory note; the drawee becomes the acceptor, and is obligated to pay the amount shown at maturity. Acceptances are negotiable instruments, which means they can be sold to another holder before maturity. (See above-mentioned Barron's Dictionary.)

Many purchasers of goods or services prefer to pay for the goods or services over a period of time rather than with a single cash payment. If the seller agrees to accept a delayed payment, the buyer and seller may then enter into financing agreement, or the seller may accept a promissory note from buyer specifying a payment amount and a future date when the payment is due, such as 90 days. The seller then holds an account receivable.

If the seller wishes to receive payment sooner than the due date on the promissory note, anticipates potential difficultly in collecting payment from the buyer, or otherwise does not wish to hold the account receivable, the seller may wish to “sell” the account receivable to a third party, such as a bank or other financial institution, in a transaction known as factoring. This is commonplace today.

Normally, these third party financial institutions agree to purchase accounts receivable only at a price somewhat less than “face” amount, because the financial institution is taking on a risk that the account receivable will turn out to be uncollectable. The amount of this discount is based on the financial institution's assessment of the credit worthiness of the seller, the collectibility of the account, and the financial institution's service fee for entering into the transaction, waiting for payment from the buyer, and perhaps instituting collection procedures if full payment is not received in a timely manner. Normally, the financial institution pays for the account receivable in two or more installments. The first payment is an “advance” to the seller, and the second payment is the balance of the face amount, paid only after collection, minus a service fee.

Accounts receivable may be purchased either “with recourse” or “without recourse.” A purchase with recourse means that the purchaser has recourse against the seller if the buyer does not pay. However, in typical factoring arrangements, even if the financial institution has recourse against the seller, the financial institutino will be subject to any claims that the buyer may have against the seller, such as claims for defective goods. This is a disadvantage for the financial institution because the financial institution had no control over the quality of the goods originally sold. Another disadvantage of the traditional factoring process is that collections of the accounts receivable may be cumbersome and time consuming, or even impossible.

U.S. Pat. No. 5,694,552 to A. Aharoni discloses a financing method that discusses the use of an instrument called a “trade acceptance draft” or “TAD”. The instrument operates somewhat like a post-dated check. The TAD is prepared by a seller and submitted to a buyer at the time of delivery of purchased goods or services. The TAD is for a specified amount, payable on a predetermined future date, and drawn against a specific bank account of the buyer maintained at a specified bank. If the buyer accepts the tendered goods, the buyer signs the TAD and returns it to the seller. The seller may then choose to sell the TAD to a third party financial institution. In such an event, the seller becomes a holder in due course of the TAD. Payment for the TAD is made to the seller in two separate payments. The first payment is considered an “advance” by the financial institution to the seller. On the maturity date of the TAD, the financial institution encodes the TAD with the name of buyer's bank and the buyer's bank account number for electronic processing within the banking system, and then deposits the TAD for collection in the normal banking system. After collection, namely after the TAD has cleared buyer's bank and full payment is paid to the financial institution, then the financial institution makes a second and final payment to seller of the balance of the face amount of the TAD, less a financial institution service fee.

One disadvantage of the method in the above-mentioned patent is that payment for the TAD from the financial institution to the seller is made in two steps. The first payment is merely an “advance.” Only after collection of the full face amount of the TAD from the buyer does the financial institution make the second and final payment to the seller, less a service fee. This extra step slows the financing process down and may render it unattractive to sellers (clients of the financial institution) because the seller must wait to receive full payment for the TAD, and may risk non-payment in certain circumstances.

Another disadvantage of the method of the above-mentioned patent is that the process for encoding the TAD with the buyer's account information for electronic processing is cumbersome, slow, error-prone and often requires the use of a special encoding machine. Often, special magnetic ink or special optically readable printing is required for effective use of electronic processing in the banking system. Even with an encoding machine, the encoding process is a burden for the financial institution that requires additional time and labor.

### SUMMARY OF THE INVENTION

To overcome the aforesaid disadvantages, disclosed is a method for extended term financing, for enabling a buyer to finance the purchase of goods or services from a seller with the services of a finance company, comprising the steps of:

the seller and the finance company enter into a time draft agreement to establish terms and conditions for extended term financing using time drafts;

the finance company provides the seller with blank time draft forms and computer encoding software for use by the seller in encoding the forms with banking information;

the seller and buyer into an agreement whereby the seller agrees to sell certain goods and services to the buyer on an extended payment term basis;

the buyer sends the buyer's bank account information to the seller, which then forwards the information to the finance company;

the finance company performs a credit investigation of the buyer and, if credit is approved, notifies the seller of the approval;

the seller ships the purchased goods or services to the buyer, prepares a time draft having a face payment amount and a future payment due date, encodes the buyer's bank account information onto a time draft using the encoding software, and sends the time draft to the buyer for signature;

upon signature, the buyer returns the time draft to the seller;

the seller tenders the time draft to the finance company for purchase;

upon approval, the finance company purchases the time draft from the seller and sends to the seller a single payment equal to the full face amount of the time draft, minus a service fee;

at the maturity date of the time draft, the finance company deposits the time draft with the finance company's regular bank in the same manner as a regular check;

the time draft passes into regular banking channels for payment of the full face amount from buyer's bank account.

Some of the benefits and and advantages of the present invention include, but are not limited to, the following:

(1) The seller receives full cash payment of the purchase price up front in a single payment from the finance company, rather than in two or more separate payments. The single payment is equal to the full face amount of the time draft minus a service fee.

(2) The seller encodes the time draft with the buyer's bank account information directly, at the seller's location using encoding software, in a format that can be processed through normal banking channels. The finance company is not required to perform any encoding. An ordinary personal computer and printer can be used. A separate encoding machine is not required.

(3) The method is efficient and fast. The collection process is minimized or eliminated. Bookkeeping and data entry requirements are reduced or eliminated.

(4) The risk to the finance company is substantially reduced because the finance company receives the buyer's bank account information and performs a credit check of the buyer before the time draft is approved for signature.

(5) No UCC filing is required, and no conflict with pre-existing credit arrangements is created.

### BRIEF DESCRIPTION OF THE DRAWINGS

These and other features and advantages of the invention will now be described with reference to the drawings of certain preferred embodiments, which are intended to illustrate and not to limit the invention, and in which like reference numbers represent corresponding parts throughout, and in which:

FIG. 1 is a block diagram showing an embodiment of the present invention;

FIG. 2 is a diagram of a sample pre-printed, blank time draft form used in the present invention; and

FIG. 3 is a diagram of a sample filled-out time draft used in the present invention.

### DETAILED DESCRIPTION OF THE INVENTION

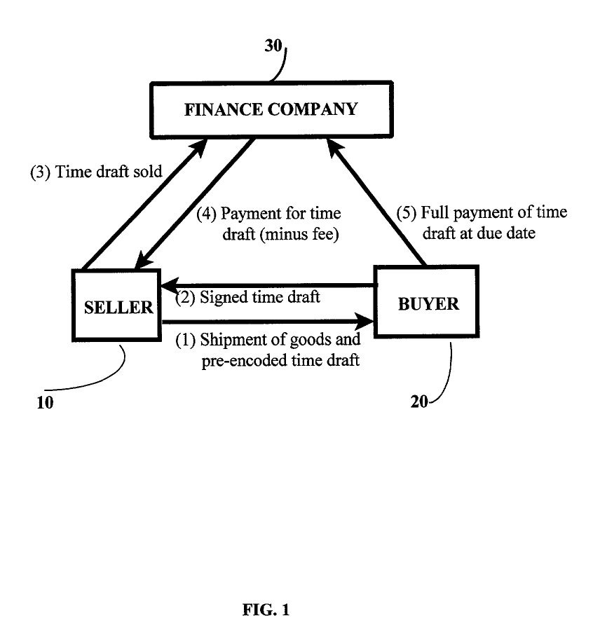

Turning now to the drawings, FIG. 1 is a simplified block diagram showing some steps of one embodiment of the present invention. A typical arrangement involves three parties—a seller 10 of goods or services; a buyer 20 of goods or services; and a finance company 30. Other entities are usually involved, although they are not shown in the diagram for clarity. They include a buyer's bank, a finance company's bank, and possibly a credit insurance company.

FIG. 1 illustrates the flow of goods, paper and money in a typical sequence. Some steps have been simplified or omitted for clarity, but are discussed in more detail below. At step (1), the seller ships certain goods or services to buyer pursuant to a previously-negotiated purchase agreement that includes extended term financing of the purchase price. The seller also prepares and sends to buyer a time draft specifying the payment amount(s) and due date(s) for payment. The seller encodes buyer's bank account information on the time draft. At step (2), the buyer signs the time draft and returns it to seller. At step (3), the finance company buys the time draft from seller and pays the seller at step (4) a single payment equal to the full purchase price minus a service fee. At step (5), on the due date, the time draft becomes the equivalent of a regular check, and the buyer pays the time draft through normal banking channels.

A more detailed typical sequence of events for a preferred embodiment of the invention is as follows:

(1) A finance company enters into a written agreement with a seller of goods or services setting forth terms, conditions, rights, obligations and procedures for a financing program involving the use of time drafts. This agreement may be referred to as a “Time Draft Agreement”. The seller may be considered the finance company's “client” and a “payee.”

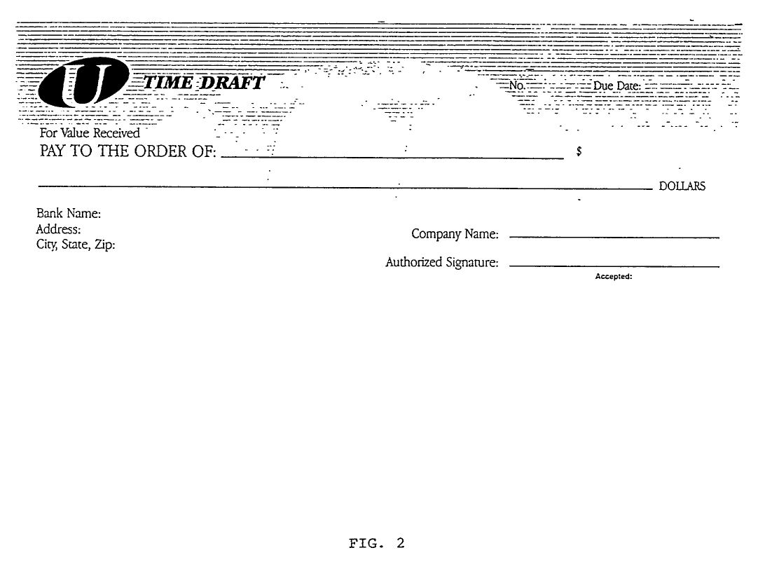

(2) Pursuant to the Time Draft Agreement, the finance company then sends proprietary computer software to the seller for use by the seller in encoding time drafts with bank account information in the proper format needed for electronic processing in the normal banking system. The finance company also sends a registration code, a password and a supply of blank time draft forms to the seller. The finance company has previously arranged for the printing of the blank time draft forms. The time draft forms preferably are paper documents similar in size to regular checks and are pre-printed with some information, similar in some ways to information pre-printed on regular blank checks. A sample of a typical pre-printed blank time draft form is shown in FIG. 2. In one embodiment of the invention, the following words are pre-printed on the form: “Time Draft”; “No.______”; “Due Date:______”; “For Value Received”; “Pay to the Order of:______”; “$______”; “______Dollars”; “Bank Name, Address, City, State, Zip: ______”; “Company Name:______”; “Authorized Signature:______”; “Accepted”. The logo of the finance company may also be pre-printed on the forms. For the seller's convenience, letter-size sheets of pre-printed, perforated forms may be supplied to the seller, to permit the seller to enter additional information (i.e., fill in the blanks) on the time drafts using a laser, ink-jet or other printer at the seller's location. It should be noted that paper time draft documents are not required. The present invention is adaptable for use in all-electronic payment systems, such as for use over the Internet.

(3) A buyer contacts the seller seeking to purchase certain of seller's goods or services. The buyer may also be considered a “customer” and a “payor.” After the buyer makes a decision to purchase, the buyer will normally send a purchase order to the seller for identified goods or services at a specified purchase price. The buyer may wish to pay the purchase price over an extended period of time.

(4) If the seller is willing to sell the goods or services at the specified price, and is willing to accept an extended payment schedule, the seller sends an acknowledgment form or proposed customer agreement to the buyer that documents the terms and conditions of the purchase, including the extended payment terms and procedures.

(5) If the buyer agrees, the buyer enters his or her bank name and address information, bank account number and routing number on the seller's acknowledgment form or customer agreement, signs it and then returns it to the seller.

(6) The seller forwards the original, signed acknowledgment form or customer agreement to the finance company and requests the finance company to conduct a pre-approval credit investigation of the buyer.

(7) The finance company conducts a credit investigation of the buyer.

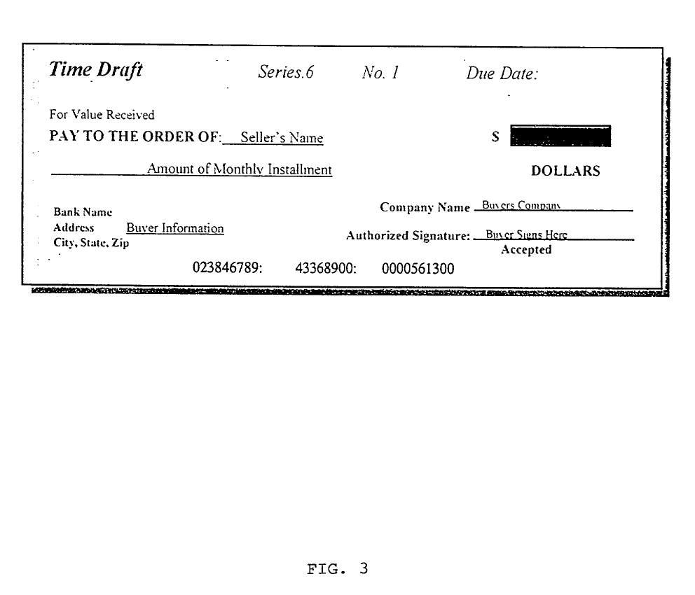

(8) If the finance company approves of buyer's credit for the amount of the purchase price of the goods or services, the finance company sends a credit approval document to the seller, or otherwise notifies the seller that credit has been approved. p1 (9) The seller ships the purchased goods or services to the buyer. p1 (10) The seller next prepares a time draft at the seller's location. The process is similar to preparing a regular check for the buyer to sign. All information required to properly document the agreed-upon extended payment is entered into a blank time draft form by the seller (i.e., the seller fills in all blanks except for the buyer's signature). For example, a face amount equal to the purchase price (or a monthly payment installment amount) is entered onto the document, together with the due date for that payment. More than one time draft may be used if several payment installments have been agreed to. The time draft may be filled out manually, but preferably it is printed with a personal computer and printer using the encoding software previously supplied by the finance company. The buyer's banking account number and routing number are printed in proper form on the time draft, preferably along the bottom edge of the document in the same manner as that used on a regular check. Using the encoding software to print the banking information enables automatic check-handling and electronic processing equipment within the normal banking system to accurately read the numbers, so that the time draft may be handled like a regular check. A sample of a typical filled-out time draft of the present invention is shown in FIG. 3. Next, the seller sends the prepared time draft (usually together with an invoice) to the buyer.

(11) Buyer receives the goods or services. Assuming buyer accepts the goods or services, buyer then signs the time draft prepared by the seller and returns it to seller as full payment for the goods or services. By signing, buyer has “accepted” the time draft. The buyer is not required to manually write down the word “accepted” because it has already been pre-printed on the time draft form. At this point, the time draft becomes a negotiable promissory note.

(12) Upon receipt of the signed time draft, the seller becomes a holder in due course. If the buyer does not accept the goods, the buyer and seller have recourse against each other, but the finance company is not involved.

(13) The seller endoreses the time draft over to the finance company in accordance with the Time Draft Agreement, and tenders the time draft to the finance company for purchase on a non-recourse basis.

(14) Upon purchase of the time draft, the finance company sends a single payment to seller equal to the full face amount of the time draft, minus a finance company service fee. This operates as payment in full to the seller. At this point, the finance company becomes a third-party holder in due course (not subject to any claims between buyer and seller), and buyer and seller normally are no longer involved.

(15) On the maturity or due date of the time draft, the time draft automatically becomes the equivalent of a regular check. The finance company deposits it in its own regular bank.

(16) The finance company's bank presents the time draft to buyer's bank through regular banking channels.

(17) The buyer is contractually responsible for ensuring that sufficient funds are available in buyer's bank account on the due date to fully cover the time draft. Assuming so, buyer's bank honors the time draft, pays the finance company's bank the full face amount of the time draft through normal banking channels, and the finance company's bank credits the finance company's bank account with the full face amount. The time draft has now “cleared” the banking process; the paid (“canceled”) time draft is eventually returned to the buyer; and the transaction is complete.

(18) If the time draft “bounces” (i.e., the buyer's bank refuses to honor the time draft for insufficient funds in the buyer's bank account), the buyer has breached its contract with the seller and possibly also committed a fraud. The finance company has paid seller anyway since payment was guaranteed in the Time Draft Agreement. The finance company's recourse is to contact the buyer directly to collect (without involving seller), or to contact the finance company's credit insurance company for settlement. If the buyer's bank refuses to honor the time draft for a reason other than insufficient funds, the finance company charges back the uncollected time draft to the seller, who is obligated to repay the amount per the Time Draft Agreement.

While the invention has been described herein with reference to certain preferred embodiments, these embodiments have been presented by way of example only, and not to limit the scope of the invention.

What is claimed is:

1. A method for extended term financing, for enabling a buyer to finance the purchase of goods or services from a seller with the services of a finance company, comprising the steps of:
the seller and the finance company enter into a time draft agreement to establish terms and conditions for extended term financing using time drafts;
the finance company provides the seller with blank time draft forms and computer encoding software for use by the seller in encoding the forms with banking information;
the seller and buyer into an agreement whereby the seller agrees to sell certain goods and services to the buyer on an extended payment term basis;
the buyer sends the buyer's bank account information to the seller, which then forwards the information to the finance company;
the finance company performs a credit investigation of the buyer and, if credit is approved, notifies the seller of the approval;
the seller ships the purchased goods or services to the buyer, prepares a time draft having a face payment amount and a future payment due date, encodes the buyer's bank account information onto a time draft using the encoding software, and sends the time draft to the buyer for signature;
upon signature, the buyer returns the time draft to the seller;
the seller tenders the time draft to the finance company for purchase;
upon approval, the finance company purchases the time draft from the seller and sends to the seller a single payment equal to the full face amount of the time draft, minus a service fee;
at the maturity date of the time draft, the finance company deposits the time draft with the finance company's regular bank in the same manner as a regular check;
the time draft passes into regular banking channels for payment of the full face amount from buyer's bank account.
